(19) United States
(12) Patent Application Publication
(10) Pub. No.: US 2018/0139477 A1
(43) Pub. Date: May 17, 2018

(54) BROADCASTING SYSTEM AND METHOD FOR INTEGRATING AND TRANSMITTING SIGNALINGS OF PLURALITY OF ENCODERS IN GROUND RADIO WAVE UHD BROADCASTING SERVICE

(71) Applicant: AIRCODE CO., LTD., Seoul (KR)

(72) Inventors: Seog Goo HONG, Seoul (KR); June LEE, Gyeonggi-do (KR); Myung Je CHO, Gyeonggi-do (KR)

(21) Appl. No.: 15/812,346

(22) Filed: Nov. 14, 2017

(30) Foreign Application Priority Data
Nov. 17, 2016 (KR) 10-2016-0153574

(51) Int. Cl. H04N 21/2368

(52) U.S. Cl. CPC H04N 21/2368; H04N 21/8543

(57) ABSTRACT

Provided are a broadcasting system and an integrated signaling transmitting method. The system includes: a plurality of AV encoders outputting a transmission packet including an AV packet and a signaling packet by packetizing AV data and signaling information of the AV data, respectively; a signaling encoder outputting an integrated signaling packet packetized by integrating the signaling information for the plurality of respective AV data; a network switch outputting a plurality of transmission packets received from the plurality of AV encoders and the integrated signaling packet received from the signaling encoder; and a multiplexer generating a broadcasting signal by multiplexing a plurality of AV packets extracted by filtering the respective signaling packets from the plurality of transmission packets and the integrated signaling packet and transmitting the broadcasting signal to a broadcasting network.

### CROSS-REFERENCE TO RELATED APPLICATION

This application claims priority to and the benefit of Korean Patent Application No. 10-2017-0153574 filed in the Korean Intellectual Property Office on Nov. 17, 2016, the entire contents of which are incorporated herein by reference.

### BACKGROUND OF THE INVENTION

### (a) Field of the Invention

The present invention relates to a broadcasting system for integrating and transmitting signalings of a plurality of AV encoders in a ground radio wave UHD broadcasting service and a method thereof.

### (b) Description of the Related Art

The Advanced Television System Committee (ATSC) is developing a broadcasting technology specification under the name of ATSC 3.0 (ground radio wave UHD Broadcasting Transmission Standard) for an IP-based next generation ground radio wave broadcasting service. In the ATSC 3.0, it is possible to deliver various types of high-quality broadcasting services to users through convergence of the Internet and broadcasting with an IP-based transmission method.

An audio and video (AV) encoder for ground radio wave ultra-HD (UHD) broadcasting encodes AV data according to a terrestrial UHD TV broadcasting transmission/reception interface standard to generate an AV stream. Such a process includes a process in which each of the AV data and signaling information indicating the AV data is packetized to multicast the AV stream and the signaling information.

When a plurality of AV encoders transmits the AV stream and a signaling packet to a broadcasting network through a network switch for each broadcasting service, a receiving side receives a plurality of signaling packets.

For example, when the AV stream constituting one broadcasting service is constituted by Video 1, Audio 1, and Audio 2 Video 1 is generated by AV Encoder 1, Audio 1 is generated by AV Encoder 1, and Audio 2 is generated by AV Encoder 2.

However, the signaling information for the AV stream transmitted to the broadcasting service is not separately transmitted as several signaling packets, but information on Video 1, Audio 1, and Audio 2 needs to be transmitted while being in one signaling packet.

That is, the signaling information of a plurality of AV encoders needs to be integrated so that one piece of signaling information is generated and one signaling packet needs to be transmitted to a receiver. When the plurality of AV encoders generates separate signaling information in one broadcasting service and transmits the generated signaling information to the receiver, the receiver cannot process a plurality of signaling information.

However, since AV Encoder 1 has no information on Audio 2 and AV Encoder 2 does not have information on Video 1 and Audio 1, it is impossible to generate and send an integrated signaling packet in each AV encoder.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a broadcasting system for integrating and transmitting signalings of a plurality of AV encoders constituting one broadcasting service in a ground radio wave UHD broadcasting service and a method thereof.

An exemplary embodiment of the present invention provides a broadcasting system including: a plurality of AV encoders outputting a transmission packet including an AV packet and a signaling packet by packetizing AV data and signaling information of the AV data, respectively; a signaling encoder outputting an integrated signaling packet packetized by integrating the signaling information for the plurality of respective AV data; a network switch outputting a plurality of transmission packets received from the plurality of AV encoders and the integrated signaling packet received from the signaling encoder; and a multiplexer generating a broadcasting signal by multiplexing a plurality of AV packets extracted by filtering the respective signaling packets from the plurality of transmission packets and the integrated signaling packet and transmitting the broadcasting signal to a broadcasting network.

The signaling encoder may extract the respective signaling packets from the plurality of transmission packets received from the network switch, and, generate an integrated signaling packet obtained by integrating the respective extracted signaling packets and output the generated integrated signaling packet to the network switch.

The signaling encoder may, when the plurality of transmission packets is packetized in a real-time object delivery over unidirectional transport (ROUTE) protocol format, extract a service layer signaling (SLS) packet including information for signaling the AV data from each of the ROUTE packets, and, generate one integrated SLS packet including the signaling information extracted from each SLS packet and output the generated integrated SLS packet to the network switch, and the multiplexer, may filter the respective SLS packets in the ROUTE packets received from the network switch and multiplex the ROUTE packets in which the respective SLS packets are filtered and the one integrated SLS packet.

The SLS packet may include a service-based transport session instance description (S-TSID) and a media presentation description (MPD), the signaling information, may be included in an LS element of the S-TSID and an AdaptationSet element of the MPD, and, the signaling encoder may generate the one integrated SLS packet including one integrated S-TSID including the LS elements of the respective SLS packets and one integrated MPD including the AdaptationSet elements of the respective SLS packets.

The signaling encoder may, when the plurality of transmission packets is packetized in an MPEG media transport (MMT) protocol format, extract a service layer signaling (SLS) packet including information for signaling the AV data from each of the MMT packets, and generate one integrated SLS packet including the signaling information extracted from each SLS packet and output the generated integrated SLS packet to the network switch, and the multiplexer may filter the respective SLS packets in the MMT packets received from the network switch and multiplex the MMT packets in which the respective SLS packets are filtered and the one integrated SLS packet.

The SLS packet may include an MMT package (MP) table, the signaling information may be included in an asset of the MP table, and, the signaling encoder may generate the one integrated SLS packet including one integrated MP table including the assets of the respective SLS packets.

The signaling encoder may receive information for signaling respective AV data from the plurality of AV encoders, and generate an integrated signaling packet including all of the respective received signaling packets and output the generated integrated signaling packet to the network switch.

The signaling encoder may receive respective service-based transport session instance descriptions (S-TSIDs) and the media presentation descriptions (MPDs) including the signaling information from the plurality of AV encoders, generate one integrated S-TSID including all of the LS elements extracted from the respective S-TSIDs and one integrated MPDs including the AdaptationSet elements extracted from the respective MPDs, and generate one integrated SLS packet including the one integrated S-TSID and the one integrated MPD and output the generated integrated SLS packet to the network switch.

The signaling encoder may receive the respective MMT package (MP) tables including the signaling information from the plurality of AV encoders, generate one integrated MP table including all assets extracted from the respective MP tables, and generate one integrated SLS packet including one integrated MP table and output the generated integrated SLS packet to the network switch.

The broadcasting signal may meet the Advanced Television System Committee (ATSC) 3.0 format which is a ground radio wave UHD broadcasting standard.

Another exemplary embodiment of the present invention provides a method for transmitting an integrated signaling by a signaling encoder, including: receiving a plurality of transmission packets including AV packets transmitted by a plurality of AV encoders, respectively and signaling packets for the AV packets; generating one integrated signaling packet by integrating the respective signaling packets extracted from the plurality of transmission packets; and outputting the integrated signaling packet to a network switch, in which, the network switch, outputs the plurality of transmission packets received from the plurality of AV encoders and the integrated signaling packet received from the signaling encoder to a multiplexer, and, the multiplexer, transmits a broadcasting signal generated by multiplexing a plurality of AV packets extracted by filtering the respective signaling packets from the plurality of transmission packets and the integrated signaling packet to the broadcasting network.

The plurality of transmission packets may be a real-time object delivery over unidirectional transport (ROUTE) protocol packet, the generating of the integrated signaling packet may include, extracting respective service layer signaling (SLS) packets from received ROUTE packets, extracting respective service-based transport session instance descriptions (S-TSIDs) and respective media presentation descriptions (MPDs) from the respective SLS packets, generating one integrated S-TSID including all respective LS elements extracted from the respective S-TSIDs, generating one integrated MPD including all respective AdaptationSet elements extracted from the respective MPDs, and generating one integrated SLS packet including the one integrated S-TSID and the one integrated MPD, and the LS element and the adaptationSet element, may include information for signaling AV data.

The receiving of the plurality of transmission packets may include receiving respective service layer signaling tables (SLTs) among low level signaling (LLS) packets in which a plurality of designated first multicast IP addresses and port numbers are transmitted, extracting a plurality of second multicast IP addresses and port numbers in which the respective SLS packets are transmitted from the respective SLTs, and receiving the ROUTE packets transmitted to the plurality of second multicast IP addresses and port numbers.

The receiving of the respective SLS packets may include receiving a layered coding transport (LCT) session in which a transport session identifier (TSI) has a designated value in each of the ROUTE packets, and checking transport object identifiers (TOIs) in the respective ROUTE packets and receiving the respective SLS packets in the respective LCT sessions by using the respective checked TOIs.

The plurality of transmission packets may be an MPEG media transport (MMT) protocol packet, the generating of the integrated signaling packet, may include extracting respective service layer signaling (SLS) packets from received MMT packets, extracting respective MMT package (MP) tables from the respective SLS packets, generating one integrated MP table including all respective assets extracted from the respective MP tables, and generating one integrated SLS packet including the one integrated MP table, and the asset, may include information for signaling AV data.

The receiving of the plurality of transmission packets may include receiving respective service layer signaling tables (SLTs) among low level signaling (LLS) packets in which a plurality of designated first multicast IP addresses and port numbers are transmitted, extracting a plurality of second multicast IP addresses and port numbers in which the respective SLS packets are transmitted from the respective SLTs, and receiving the MMT packets transmitted to the plurality of second multicast IP addresses and port numbers.

The receiving of the respective SLS packets may include receiving packets in which respective packet identifier (Packet ID) have designated values, respectively among the MMT packets, and checking an MMT message identifier (ID) in the received packets and extracting the respective SLS packets.

Yet another exemplary embodiment of the present invention provides a method for transmitting an integrated signaling by a signaling encoder, including: receiving information for signaling respective AV data from a plurality of AV encoders; generating an integrated signaling packet including all of the respective received signaling information; and outputting the integrated signaling packet to a network switch, in which, the network switch, outputs the plurality of transmission packets received from the plurality of AV encoders and the integrated signaling packet received from the signaling encoder to a multiplexer, and the multiplexer, transmits a broadcasting signal generated by multiplexing a plurality of AV packets extracted by filtering the respective signaling packets from the plurality of transmission packets and the integrated signaling packet to the broadcasting network.

In the receiving, respective service-based transport session instance descriptions (S-TSIDs) and the media presentation descriptions (MPDs) including the signaling information are received from the plurality of AV encoders, and the generating of the integrated signaling packet, may include generating one integrated S-TSID including all LS elements extracted from the respective S-TSIDs, generating one integrated MPD including all AdaptationSet elements extracted from the respective MPDs, and generating one integrated SLS packet including the one integrated S-TSID and the one integrated MPD.

In the receiving, the respective MMT package (MP) tables including the signaling information are received from the plurality of AV encoders, and the generating of the integrated signaling packet, may include generating one integrated MP table including all assets extracted from the respective MP tables, and generating one integrated SLS packet including the one integrated MP table.

According to exemplary embodiments of the present invention, integrated signaling information for an entire broadcasting service can be transmitted.

### BRIEF DESCRIPTION OF THE DRAWINGS

FIG. 1 is a diagram schematically illustrating a configuration of a broadcasting system according to an exemplary embodiment of the present invention.

FIG. 2 is a diagram illustrating a configuration of generating an integrated signaling packet according to an exemplary embodiment of the present invention.

FIG. 3 is a diagram illustrating a configuration of generating an integrated signaling packet according to another exemplary embodiment of the present invention.

FIG. 4 is a flowchart illustrating a process of extracting a signaling packet according to an exemplary embodiment of the present invention.

FIG. 5 illustrates a ROUTE session according to an exemplary embodiment of the present invention.

FIG. 6 illustrates a transport object identifier (TOI) format in a ROUTE packet according to an exemplary embodiment of the present invention.

FIG. 7 is a flowchart illustrating a process of extracting a signaling packet according to another exemplary embodiment of the present invention.

FIG. 8 illustrates a format of an MPT message according to an exemplary embodiment of the present invention.

FIG. 9 is a flowchart illustrating a process of generating an integrated signaling packet according to an exemplary embodiment of the present invention.

FIG. 10 is a flowchart illustrating a process of generating an integrated signaling packet according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification

Through the specification, unless explicitly described to the contrary, the word “comprise” and variations such as “comprises” or “comprising”, will be understood to imply the inclusion of stated elements but not the exclusion of any other elements.

In addition, the terms “-er”, “-or” and “module” described in the specification mean units for processing at least one function and operation and can be implemented by hardware components or software components and combinations thereof.

In the present specification, a broadcasting signal may meet the Advanced Television System Committee (ATSC) 3.0 format, which is a ground radio wave ultra high definition (UHD) standard.

In this case, there are two exemplary embodiments of an IP protocol for service delivery through a broadcasting network of the broadcasting signal.

A protocol according to one exemplary embodiment is a real time object delivery over unidirectional transport (ROUTE) protocol for transmitting an MPEG dynamic adaptive streaming over HTTP (DASH) segment.

The protocol according to another exemplary embodiment is an MPEG media transport protocol (MMTP) for transmitting media processing units (MPU).

Hereinafter, a system and a method for integrating and transmitting signalings of a plurality of AV encoders in a ground radio wave UHD broadcasting service and a method thereof according to exemplary embodiments of the present invention will be described with reference to drawings.

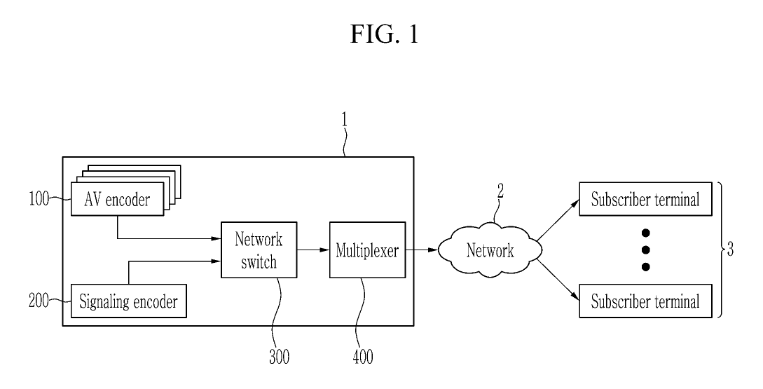

FIG. 1 is a diagram schematically illustrating a configuration of a broadcasting system according to an exemplary embodiment of the present invention.

Referring to FIG. 1, broadcasting signals transmitted by a broadcasting system 1 are broadcasted to subscriber terminals 3 through a network 2.

Here, the broadcast system 1 includes a plurality of audio and video (AV) encoders 100, a signaling encoder 200, a network switch 300, and a multiplexer (Mux) 400.

The plurality of AV encoders 100 encodes generated audio and video data according to a ground radio wave UHD TV broadcast transmission/reception interface standard.

The plurality of AV encoders 100 packetizes AV data and signaling information indicating the AV data, respectively to generate AV packets and signaling packets, respectively and transmits transmission packets including the AV packets and the signaling packets to the network switch 300.

Here, the signaling information indicates information regarding the AV data transmitted by each AV encoder 100. That is, only each AV encoder 100 generates only signaling information for the AV data generated thereby.

In this case, a packetizing scheme may adopt the ROUTE protocol scheme or the MMT protocol scheme. A ROUTE protocol and an MMT protocol are configured to generate the signaling information by different schemes.

The signaling encoder 200 generates an integrated signaling packet including all of the signaling information for the plurality of AV data for each broadcasting service and multicasts the generated signaling packet to the network switch 300.

The network switch 300 receives a plurality of multicast transmission packets (AV packets and signaling packets) from the plurality of AV encoders 100. Then, the network switch 300 receives the integrated signaling packet multicasted by the signaling encoder 200.

The multiplexer 400 receives the AV packets and the signaling packets transmitted by the respective AV encoders 100 from the network switch 300 and thereafter, filters and discards the signaling packet transmitted by the AV encoder 100 and extracts only the AV packet. In addition, the respective extracted AV packets and the integrated signaling packet received from the signaling encoder 200 are multiplexed to generate the broadcasting signal. Then, the broadcasting signal is transmitted to the broadcasting network 2.

Here, there are two exemplary embodiments in which the signaling encoder 200 generates the integrated signaling packet.

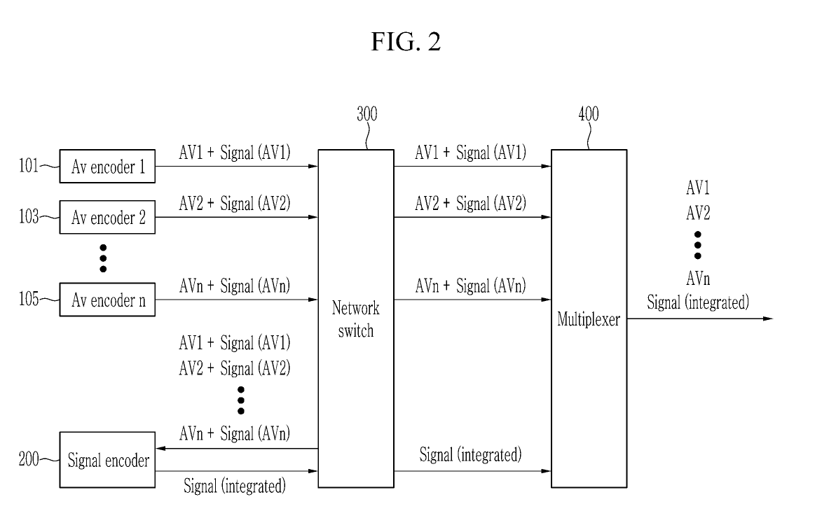

FIG. 2 is a diagram illustrating a configuration of generating an integrated signaling packet according to an exemplary embodiment of the present invention.

Referring to FIG. 2, AV encoder 1 101 outputs a transmission packet including AV data AV1 and signaling information on the AV data AV1 to the network switch 300.

AV encoder 2 103 outputs a transmission packet including AV data AV2 and signaling information on the AV data AV2 to the network switch 300.

AV encoder n 105 outputs a transmission packet including AV data AVn and signaling information on the AV data AVn to the network switch 300.

The network switch 300 multicasts respective transmission packets received from a plurality (n) of AV encoders 101, 103, and 105.

In this case, the signaling encoder 200 receives a plurality of transmission packets (AV1+signal AV1, AV2+signal AV2, . . . , and AVn+signal AVn) from the network switch 300.

The signaling encoder 200 extracts respective signaling packets (signal AV1, signal AV2, . . . , and signal AVn) from the plurality of transmission packets (AV1+signal AV1, AV2+signal AV2, . . . , and AVn+signal AVn). In addition, the extracted signaling packets are integrated to generate one integrated signaling packet (signal (integrated)) and output the generated signaling packet to the network switch 300.

The network switch 300 receives and outputs the plurality of transmission packets (AV1+signal AV1, AV2+signal AV2, AVn+signal AVn)) and the integrated signaling packet (signal (integrated)) to the multiplexer 400.

The multiplexer 400 filters the respective signaling packets (signal AV1, signal AV2, . . . , and signal AVn) from the plurality of transmission packets (AV1+signal AV1, AV2+signal AV2, AVn+signal AVn) to extract only the AV packets (AV1, AV2, . . . , and AVn). In addition, the extracted AV packets (AV1, AV2, . . . , and AVn) and the integrated signaling packet (signal (integrated)) are multiplexed and output.

In this case, a scheme that generates the integrated signaling packet by extracting the signaling packets varies for each of the ROUTE protocol and the MMT protocol.

When the plurality of transmission packets is packetized in a real-time object delivery over unidirectional transport (ROUTE) protocol format, the signaling encoder 200 extracts a service layer signaling (SLS) packet including information indicating the AV data from ROUTE packets transmitted by the AV encoder 100.

The SLS provides detailed technical information to the receiver (not shown) to enable discovery and access of the service and content components thereof.

The signaling encoder 200 generates one integrated SLS packet including the signaling information extracted from each SLS packet and outputs the generated SLS packet to the network switch 300.

In this case, information on AV packet transmission in the ROUTE SLS is included in a service-based transport session instance description (S-TSID) and a media presentation description (MPD).

The information on the transmission of AV packets transmitted using a combination of an LS element (LCT channel information) of the S-TSID and AdaptationSet element of the MPD is displayed. Here, the LS Element has information on an LCT session transmitted in a ROUTE session as LCT channel information.

The signaling encoder 200 extracts the S-TSID from the SLS packets transmitted from the plurality of AV encoders 100 and combines the LS elements included in the S-TSID to generate one integrated S-TSID. Then, MPD is extracted from each SLS packet and AdaptationSet elements included in the MPD are combined to generate one integrated MPD. SLS information for the entire service is generated by using one integrated S-TSID and MPD and the integrated SLS is multicasted.

Then, the multiplexer 400 filters and discards the SLS packet from the ROUTE packet (integrated signaling information) transmitted by the signaling encoder 200 and the ROUTE packet transmitted by the AV encoder 100 from the network switch 300 and thereafter, multiplexes and transmits the extracted AV packets.

Further, when the plurality of transmission packets is packetized in an MPEG media transport (MMT) protocol format, the signaling encoder 200 extracts the SLS packet including the information indicating the AV data from the MMT packets transmitted by the AV encoder 100. In addition, one integrated SLS packet including signaling information extracted from each SLS packet is generated.

Here, in the case of the MMT SLS, information on AV packet transmission is included in an MMT package (MP) table. Information on the AV packet in which asset information of the MP table is transmitted is displayed.

The signaling encoder 200 extracts the MP table from the SLS packets transmitted by each of the plurality of AV encoders 100 and combines the asset information included in the MP table into one to generate one integrated MP table. In addition, one integrated SLS packet including the integrated MP table is generated.

Then, the multiplexer 400 filters and discards the respective SLS packet from the MMT packets transmitted by the AV encoder 100, which are received from the network switch 300 and thereafter, multiplexes and transmits the extracted AV packets and the MMT packets (integrated signaling information) transmitted by the signaling encoder 200.

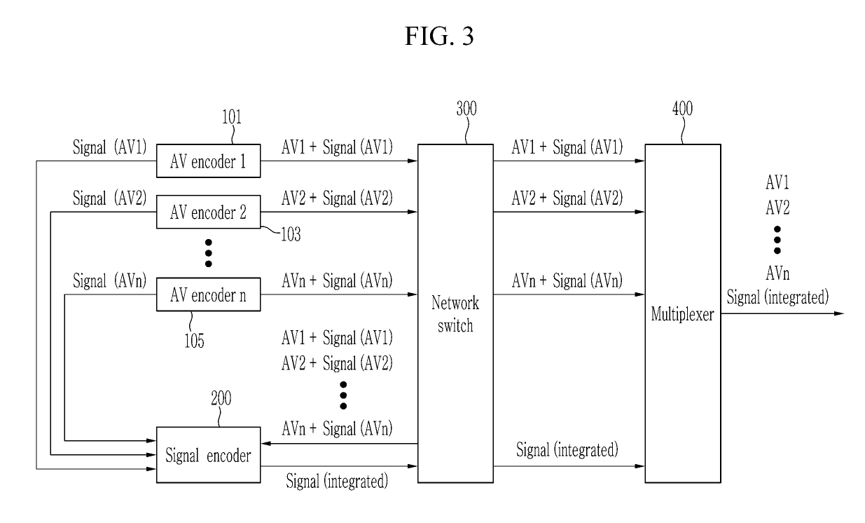

FIG. 3 is a diagram illustrating a configuration of generating an integrated signaling packet according to another exemplary embodiment of the present invention.

Referring to FIG. 3, unlike FIG. 2, the AV encoder 1 101 transmits signaling information (signal AV1) to the signaling encoder 200.

The AV encoder 2 103 transmits the signaling information (signal AV2) to the signaling encoder 200.

The AV encoder n 105 transmits the signaling information (signal AVn) to the signaling encoder 200.

The signaling encoder 200 integrates the respective signaling information (signal AV1, signal AV2, . . . , and signal AVn) received from the plurality (n) of AV encoders 100 to generate the integrated signaling packet (signal (integrated)).

Operations of the network switch 300 and the multiplexer 400 are the same as those in FIG. 2.

Here, the signaling encoder 200 may receive respective S-TSIDs and MPDs from the plurality of AV encoders 100.

The signaling encoder 200 generates one integrated S-TSID including all LS elements extracted from the respective S-TSIDs. Then, the signaling encoder 200 generates one integrated MPD including the AdaptationSet elements extracted from the respective MPDs. In addition, the signal encoder 200 generates one integrated SLS packet including one integrated S-TSID and one integrated MPD.

Here, AdaptationSet is prepared for each medium such as video, audio, and subtitles and the AdaptationSet describes information on a language, a codec, and the like.

Further, the signaling encoder 200 may receive respective MMT package (MP) tables including the signaling information from the plurality of AV encoders 100.

The signaling encoder 200 generates one integrated MP table including all assets extracted from the respective MP tables. In addition, the signaling encoder 200 generates one integrated SLS packet including one integrated MP table.

Now, a series of processes for transmitting the integrated signaling will be described.

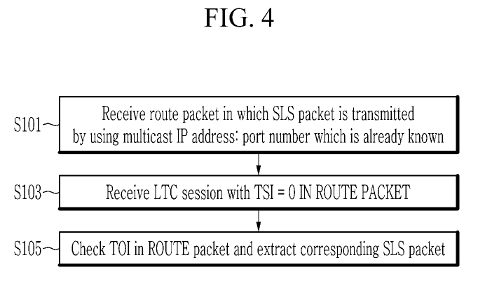

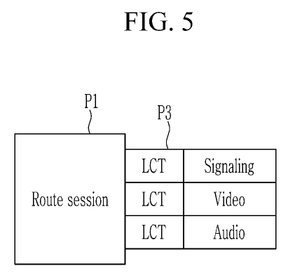

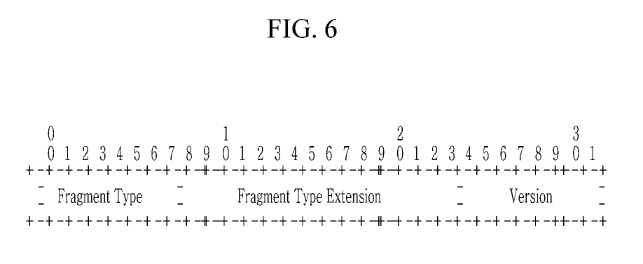

First, FIG. 4 is a flowchart illustrating a process of extracting a signaling packet (SLS) according to an exemplary embodiment of the present invention, FIG. 5 illustrates a ROUTE session according to an exemplary embodiment of the present invention, and FIG. 6 illustrates a transport object identifier (TOI) format in a ROUTE packet according to an exemplary embodiment of the present invention.

In this case, FIG. 4 illustrates a process in which the signaling encoder 200 extracts the respective signaling packets from the plurality of transmission packets in FIG. 2.

Referring to FIG. 4, the signaling encoder 200 receives the ROUTE packet in which the SLS packet is transmitted using a multicast IP address: port number transmitted from each AV encoder 100 (S101).

When the plurality of AV encoders 100 multicasts the respective signaling packets and AV packets to one broadcasting service, the signaling encoder 200 knows the multicast transmission information for each AV encoder 100. For example, in FIG. 2, the AV encoder 1 (101) transmits a ROUTE packet (AV1+signal AV1) through multicast IP address 1: port number 1. In addition, the AV encoder 2 103 transmits a ROUTE packet (AV2+signal AV2) through multicast IP address 2: port number 2.

The signaling encoder 200 receives an LCT session with a transport session identifier (TSI)=0 in the ROUTE packet (S103). The signaling packet (or SLS packet) may be transmitted only when TSI=0. Then, the transport object identifier (TOI) value is checked in the ROUTE packet and a required SLS packet is extracted (S105).

Here, referring to FIG. 5, a ROUTE session is composed of a plurality of LCT sessions and video, audio (TSI is not zero), and signaling information (TSI=0) are included for each LCT session.

The signaling encoder 200 first filters packets having TSI=0 among the received ROUTE packets and collects signaling packets. The TOI value is extracted from the collected signaling packet. The TOI value is configured by 32 bits and is illustrated in FIG. 6.

Fragment Type and Fragment Type Extension values are used to extract the S-TSID and MPD values.

When Fragment Type=0x03, a signaling packet payload includes only the S-TSID.

When Fragment Type=0x04, the signaling packet payload includes only the MPD.

In the case of Fragment Type=0x01 packaged mode, the SLS information included in the signaling packet payload may be confirmed by performing an OR operation for the Fragment Type Extension value.

When the OR operation of Fragment Type Extension value and ‘0000000000000010’ is TRUE, the S-TSID is included in the ROUTE signaling packet payload.

When the OR operation of Fragment Type Extension and ‘0000000000000100’ is TRUE, the MPD is included in the ROUTE signaling packet payload.

The SLS information included in the signaling packet load is confirmed by using the Fragment Type and Fragment Type Extension values included in the TOI and thereafter, the S-TSID and the MPD are extracted (S105).

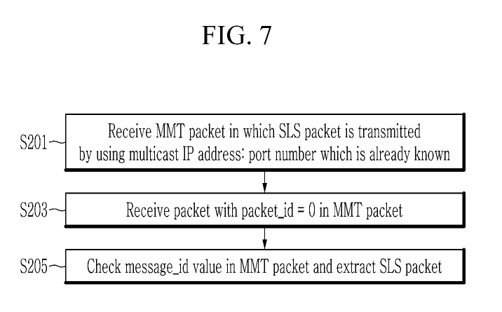

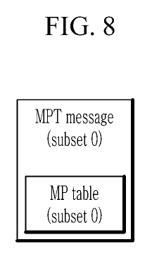

Next, FIG. 7 is a flowchart illustrating a process of extracting a signaling packet (SLS) according to another exemplary embodiment (MMT) of the present invention and FIG. 8 illustrates a format of an MPT message according to an exemplary embodiment of the present invention.

In particular, FIG. 7 illustrates a process in which the signaling encoder 200 extracts the respective signaling packets from the plurality of transmission packets in FIG. 3.

The signaling encoder 200 receives the MMT packet in which the SLS packet is transmitted using the multicast IP address: port number transmitted from the AV encoder 100 (S201).

The signaling encoder 200 receives a packet with packet_id=0 in the MMT packet (S203). Only signaling packets are sent with packet_id=0. Then, a message_id value is checked in the MMT packet to extract a required SLS packet (S205). The AV information is transmitted using the MP table and the MP table is included in the MPT message. The MPT message is illustrated in FIG. 8.

The signaling encoder 200 filters only the packet with packet_id=0 in the received MMT packet, collects the signaling packet and thereafter, filters only a message_id=0x0010 packet to find the MPT message. In the MPT message, only a table_id=0x11 packet is filtered to receive the MP table. An SNS packet is included in the MP table.

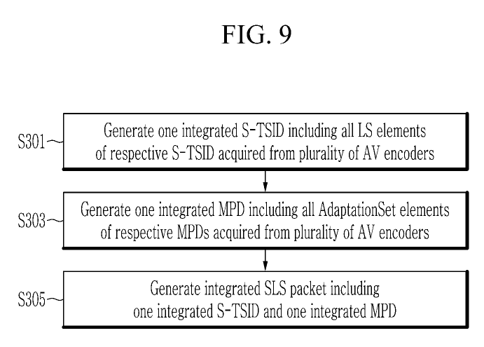

FIG. 9 is a flowchart illustrating a process of generating an integrated signaling packet according to an exemplary embodiment of the present invention and corresponds to a case of following the ROUTE protocol format.

Referring to FIG. 9, the signaling encoder 200 generates one integrated S-TSID including all the LS elements of the respective S-TSIDs acquired from the plurality of AV encoders 100 (S301).

Among the ROUTE signaling information, the information on the AV packet is included in the S-TSID and the MPD.

The signaling encoder 200 generates one integrated MPD including all the AdaptationSet elements of the respective MPDs acquired from the plurality of AV encoders 100 (S303).

The signaling encoder 200 generates the integrated SLS packet including one integrated S-TSID and one integrated MPD (S305).

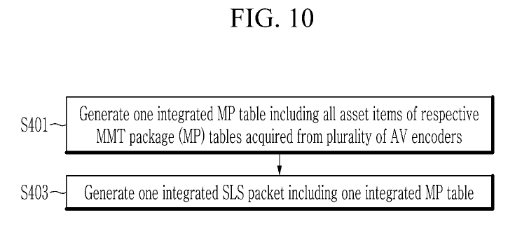

FIG. 10 is a flowchart illustrating a process of generating an integrated signaling packet according to another exemplary embodiment of the present invention and corresponds to a case of following the MMT protocol format.

Referring to FIG. 10, the signaling encoder 200 generates one integrated MP table including all asset items of the respective MMT package (MP) tables acquired from the plurality of AV encoders 100 (S401).

The signaling encoder 200 generates one integrated SLS packet including one integrated MP table (S403).

The exemplary embodiments of the present invention described above can be implemented not only through the apparatus and the method and can be implemented through a program which realizes a function corresponding to a configuration of the exemplary embodiments of the present invention or a recording medium having the program recorded therein.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A broadcasting system comprising:
a plurality of AV encoders outputting a transmission packet including an AV packet and a signaling packet by packetizing AV data and signaling information of the AV data, respectively;
a signaling encoder outputting an integrated signaling packet packetized by integrating the signaling information for the plurality of respective AV data;
a network switch outputting a plurality of transmission packets received from the plurality of AV encoders and the integrated signaling packet received from the signaling encoder; and
a multiplexer generating the broadcasting signal by multiplexing a plurality of AV packets extracted by filtering the respective signaling packets from the plurality of transmission packets and the integrated signaling packet and transmitting the broadcasting signal to a broadcasting network.

2. The broadcasting system of claim 1, wherein:
the signaling encoder,
extracts the respective signaling packets from the plurality of transmission packets received from the network switch, and,
generates an integrated signaling packet obtained by integrating the respective extracted signaling packets and outputs the generated integrated signaling packet to the network switch.

3. The broadcasting system of claim 2, wherein:
the signaling encoder,
when the plurality of transmission packets is packetized in a real-time object delivery over unidirectional transport (ROUTE) protocol format,
extracts a service layer signaling (SLS) packet including information for signaling the AV data from each of the ROUTE packets, and
generates one integrated SLS packet including the signaling information extracted from each SLS packet and outputs the generated integrated SLS packet to the network switch, and
the multiplexer,
filters the respective SLS packets in the ROUTE packets received from the network switch and multiplexes the ROUTE packets in which the respective SLS packets are filtered and the one integrated SLS packet.

4. The broadcasting system of claim 3, wherein:
the SLS packet,
includes a service-based transport session instance description (S-TSID) and a media presentation description (MPD),
the signaling information,
is included in an LS element of the S-TSID and an AdaptationSet element of the MPD, and
the signaling encoder,
generates the one integrated SLS packet including one integrated S-TSID including the LS elements of the respective SLS packets and one integrated MPD including the AdaptationSet elements of the respective SLS packets.

5. The broadcasting system of claim 2, wherein:
the signaling encoder,
when the plurality of transmission packets is packetized in an MPEG media transport (MMT) protocol format,
extracts a service layer signaling (SLS) packet including information for signaling the AV data from each of the MMT packets, and
generates one integrated SLS packet including the signaling information extracted from each SLS packet and outputs the generated integrated SLS packet to the network switch, and
the multiplexer,
filters the respective SLS packets in the MMT packets received from the network switch and multiplexes the MMT packets in which the respective SLS packets are filtered and the one integrated SLS packet.

6. The broadcasting system of claim 5, wherein:
the SLS packet,
includes an MMT package (MP) table,
the signaling information,
is included in an asset of the MP table, and
the signaling encoder,
generates the one integrated SLS packet including one integrated MP table including the assets of the respective SLS packets.

7. The broadcasting system of claim 1, wherein:
the signaling encoder,
receives information for signaling respective AV data from the plurality of AV encoders, and
generates an integrated signaling packet including all of the respective received signaling information and outputs the generated integrated signaling packet to the network switch.

8. The broadcasting system of claim 7, wherein:
the signaling encoder,
receives respective service-based transport session instance descriptions (S-TSIDs) and respective media presentation descriptions (MPDs) including the signaling information from the plurality of AV encoders
generates one integrated S-TSID including all of the LS elements extracted from the respective S-TSIDs and one integrated MPDs including the AdaptationSet elements extracted from the respective MPDs, and
generates one integrated SLS packet including the one integrated S-TSID and the one integrated MPD and outputs the generated integrated SLS packet to the network switch.

9. The broadcasting system of claim 7, wherein:
the signaling encoder,
receives respective MMT package (MP) tables including the signaling information from the plurality of AV encoders,
generates one integrated MP table including all assets extracted from the respective MP tables, and
generates one integrated SLS packet including one integrated MP table and outputs the generated integrated SLS packet to the network switch.

10. The broadcasting system of claim 1, wherein:
the broadcasting signal,
meets the Advanced Television System Committee (ATSC) 3.0 format which is a ground radio wave UHD broadcasting standard.

11. A method for transmitting an integrated signaling by a signaling encoder, the method comprising:
receiving a plurality of transmission packets including AV packets transmitted by a plurality of AV encoders, respectively and signaling packets for the AV packets;
generating one integrated signaling packet by integrating the respective signaling packets extracted from the plurality of transmission packets; and
outputting the integrated signaling packet to a network switch,
wherein the network switch
outputs the plurality of transmission packets received from the plurality of AV encoders and the integrated signaling packet received from the signaling encoder to a multiplexer, and
the multiplexer,
transmits a broadcasting signal generated by multiplexing a plurality of AV packets extracted by filtering the respective signaling packets from the plurality of transmission packets and the integrated signaling packet to the broadcasting network.

12. The method of claim 11, wherein:
the plurality of transmission packets,
is a real-time object delivery over unidirectional transport (ROUTE) protocol packet,
the generating of the integrated signaling packet includes
extracting respective service layer signaling (SLS) packets from received ROUTE packets,
extracting respective service-based transport session instance descriptions (S-TSIDs) and respective media presentation descriptions (MPDs) from the respective SLS packets,
generating one integrated S-TSID including all respective LS elements extracted from the respective S-TSIDs,
generating one integrated MPD including all respective AdaptationSet elements extracted from the respective MPDs, and
generating one integrated SLS packet including the one integrated S-TSID and the one integrated MPD, and
the LS element and the adaptationSet element,
include information for signaling AV data.

13. The method of claim 12, wherein:
in the receiving of the plurality of transmission packets,
the ROUTE protocol packet in which the SLS packet is transmitted is received by using respective multicast IP addresses and port numbers which are known in advance.

14. The method of claim 13, wherein:
the receiving of the respective SLS packets includes,
receiving a layered coding transport (LCT) session in which a transport session identifier (TSI) has a designated value in each of the ROUTE packets, and
checking transport object identifiers (TOIs) in the respective ROUTE packets and receiving the respective SLS packets in the respective LCT sessions by using the respective checked TOIs.

15. The method of claim 11, wherein:
the plurality of transmission packets,
is an MPEG media transport (MMT) protocol packet, and,
the generating of the integrated signaling packet includes,
extracting respective service layer signaling (SLS) packets from received MMT packets,
extracting respective MMT package (MP) tables from the respective SLS packets,
generating one integrated MP table including all respective assets extracted from the respective MP tables, and
generating one integrated SLS packet including the one integrated MP table, and
the asset,
includes information for signaling AV data.

16. The method of claim 15, wherein:
in the receiving of the plurality of transmission packets,
the MMT packets in which the respective SLS packets are transmitted are received by using respective multicast IP addresses and port numbers which are known in advance.

17. The method of claim 16, wherein:
the receiving of the respective SLS packets includes,
receiving packets in which respective packet identifier (Packet ID) have designated values, respectively among the MMT packets, and
checking an MMT message identifier (ID) in the received packets and extracting the respective SLS packets.

18. A method for transmitting an integrated signaling by a signaling encoder, the method comprising:
receiving information for signaling respective AV data from a plurality of AV encoders;
generating an integrated signaling packet including all of the respective received signaling information; and
outputting the integrated signaling packet to a network switch,
wherein the network switch
outputs the plurality of transmission packets received from the plurality of AV encoders and the integrated signaling packet received from the signaling encoder to a multiplexer, and
the multiplexer,
transmits a broadcasting signal generated by multiplexing a plurality of AV packets extracted by filtering the respective signaling packets from the plurality of transmission packets and the integrated signaling packet to the broadcasting network.

19. The method of claim 18, wherein:
in the receiving,
respective service-based transport session instance descriptions (S-TSIDs) and the media presentation descriptions (MPDs) including the signaling information are received from the plurality of AV encoders, and
the generating of the integrated signaling packet includes,
generating one integrated S-TSID including all LS elements extracted from the respective S-TSIDs,
generating one integrated MPD including AdaptationSet elements extracted from the respective MPDs, and
generating one integrated SLS packet including the one integrated S-TSID and the one integrated MPD.

20. The method of claim 18, wherein:
the receiving includes,
the respective MMT package (MP) tables including the signaling information are received from the plurality of AV encoders, and
the generating of the integrated signaling packet includes,
generating one integrated MP table including all assets extracted from the respective MP tables, and
generating one integrated SLS packet including the one integrated MP table.
